(19) United States
(12) Patent Application Publication
(10) Pub. No.: US 2026/0057794 A1
(43) Pub. Date: Feb. 26, 2026

(54) METHOD AND DEVICE WITH VISUAL INDICATORS FOR PERFORMING CARDIOPULMONARY RESUSCITATION (CPR)

(71) Applicant: Colleen McGowan, Matawan, NJ (US)

(72) Inventor: Colleen McGowan, Matawan, NJ (US)

(21) Appl. No.: 19/260,333

(22) Filed: Jul. 4, 2025

Related U.S. Application Data
(63) Continuation-in-part of application No. 18/517,761, filed on Nov. 22, 2023.
(60) Provisional application No. 63/465,951, filed on May 12, 2023.

(51) Int. Cl. G09B 5/02; F21V 31/00; F21Y 113/13; F21Y 115/10; H05B 47/16

(52) U.S. Cl. CPC G09B 5/02; F21V 31/005; H05B 47/16; F21Y 2113/13; F21Y 2115/10

(57) ABSTRACT

The described device(s) are to be used by an individual on a patient during CPR. An exemplary device is configured to alert an individual to the real-time number of compressions and/or resuscitations required on the patient during CPR. The device may include a rectangular housing including a plurality of light sources, a battery, a timer circuit, and an activation mechanism. The housing may further include an adhesive and be configured to be placed on the body of a patient. The removable adhesive may allow for the device to be easily disposed of after a single use, and further, allows for the device to be easily portable and placed on the body of the patient while in use.

### CLAIM OF PRIORITY

This application claims priority to U.S. application Ser. No. 18/517,761 filed on Nov. 22, 2023, which claims priority to U.S. application Ser. No. 63/465,951 filed on May 12, 2023, the contents of both of which are herein fully incorporated by reference in their entirety.

### FIELD OF THE EMBODIMENTS

The present invention and its embodiments pertain to the field of medical devices, specifically to devices having visual indicators designed for use during cardiopulmonary resuscitation (CPR). In particular, the present invention and its embodiments focus on improving the effectiveness and efficiency of CPR performed by rescuers in various settings.

### BACKGROUND OF THE EMBODIMENTS

Cardiopulmonary resuscitation (CPR) is an essential emergency procedure used in critical situations such as cardiac arrest, where the heart stops beating or otherwise beats ineffectively. The main objective of CPR is to restore partial flow of oxygenated blood to the brain and heart, extending the window for successful resuscitation without permanent brain damage. This life-saving technique involves chest compressions combined with resuscitation breaths, either by mouth-to-mouth resuscitation or with the aid of a device providing positive pressure ventilation. The effectiveness of CPR significantly influences the survival rate and long-term outcome in cases of cardiac arrest, making proficiency in its application crucial.

The American Heart Association (AHA) provides specific guidelines for performing CPR, which vary based on the age of the patient. For adults, the AHA recommends a rate of 100 to 120 chest compressions per minute, with each compression being at least two inches deep and allowing the chest to completely recoil between compressions. In addition to chest compressions, it is advised to provide two resuscitative breaths after every 30 compressions. In the case of infants and pediatric patients, the guideline remains 100 to 120 compressions per minute, but the depth of compressions differs: about 1.5 inches for infants and about 2 inches for pediatrics. The ratio of compressions to breaths in a one-rescuer scenario is 30 compressions followed by two breaths, similar to adults. However, in a two-rescuer scenario for infants and pediatrics, the ratio changes to 15 compressions followed by two breaths, acknowledging the higher oxygen demand in these younger patients.

Despite the widespread training in CPR techniques, the actual application in real-life scenarios often falls short of these recommended standards, leading to lower survival rates. Factors such as stress, panic, physical fatigue, and the lack of real-time feedback can significantly impair the quality of CPR administered. This discrepancy between training and real-life application highlights a critical gap in the current approach to CPR.

In response to this issue, various CPR assistance devices have been developed, ranging from simple metronomes to sophisticated machines that provide auditory or visual cues to guide the compression rate. However, these devices have several limitations. One major drawback is that sophisticated machines may not always be readily available to rescuers. Additionally, providing feedback from these devices on a screen can be challenging because the optimal CPR technique requires proper body positioning over the victim, which can make it difficult to see the monitor clearly. Bright lighting environments can hinder the visibility of device screens, environmental factors may also interfere with the device signals, which can reduce their reliability.

Another limitation of current CPR assistance devices is their complexity and cost. Some of the more sophisticated devices are expensive and require significant training to use effectively. This restricts their availability, particularly in public places or resource-limited settings where they might be most needed. Furthermore, in high-stress scenarios such as cardiac arrest, even healthcare professionals may find it challenging to operate complex devices efficiently. The need for a device that is intuitive, easy to use, providing proper CPR guidance, regardless of the user's level of training, is therefore evident.

Additionally, the issue of skill retention poses a significant challenge in the field of CPR. Studies have shown that proficiency in CPR techniques declines over time if not regularly practiced. This decay in skills can lead to ineffective CPR when it is most needed. Current training methods and devices do not adequately address this issue, emphasizing the need for a solution that not only assists during CPR but also helps maintain and refresh the skills of potential rescuers.

The primary problem, therefore, is the absence of a simple, intuitive, and adaptive device that can provide real-time, patient-specific guidance during CPR. Such a device should ideally be accessible and easy to use for individuals with varying levels of training, including untrained bystanders, and adaptable to different patient needs. The device should guide the rescuer in maintaining the correct rate of compressions and assist with the timing of rescue breaths all while being cost-effective and easy to deploy in various emergency situations.

The importance of effective CPR cannot be overstated, as it is often the critical factor determining the survival and long-term outcome of individuals experiencing cardiac arrest. The development of new technologies and devices in this field is thus of paramount importance. An ideal solution would bridge the gap between training and real-life application, ensuring that high-quality CPR is delivered consistently, irrespective of the rescuer's background or the patient's specific characteristics. This need for innovation in the field of emergency medical equipment underscores the significance of advancements that can be widely disseminated and utilized in a range of environments, from healthcare settings to public spaces.

### SUMMARY OF THE EMBODIMENTS

The present invention relates to a device with one or more visual indicators designed for use in cardiopulmonary resuscitation (CPR). This device is configured to provide real-time guidance on the number of compressions and rescue breaths required during CPR. It may comprise a rectangular housing containing a plurality of light sources, a battery, a timer circuit, and an activation mechanism. The housing includes a removable tab configured to expose an adhesive, allowing it to be placed directly on the patient's body within direct sight of the rescuer(s) performing CPR. The visual indicator is triggered upon removal of the release liner tab, facilitating immediate operational readiness. Additionally, the device features a timer circuit in electronic communication with the light sources, which can be adjusted based on the number of rescuers(one rescuer or two man rescuers).

The device introduced in this invention offers numerous advantages over existing CPR assistance technologies. A key feature is its real-time guidance mechanism, which aids rescuers in maintaining the appropriate rate of compression and respirations, critical factors in quality CPR. Distinct from many existing devices, this invention has various models for varying patient age groups and number of rescuers, as well as when an advanced airway is present, thus enhancing its utility across diverse CPR scenarios. One notable innovation is the incorporation of separate lights for each action (compressions, rescue breaths, providing clear, distinct visual cues for each required action. This feature simplifies the CPR process, allowing for more accurate and timely responses, particularly important in high-stress emergency scenarios.

The device's intuitive design, characterized by a simple activation mechanism through the removal of the release liner tab, immediate visual guidance from light sources, ensures ease of use, even for those under extreme pressure. Its portable and user-friendly nature broadens its applicability, making it an essential tool not only for professional healthcare providers but also for the untrained bystander. By effectively bridging the gap between CPR training and real-world application, the invention will significantly improve the quality of emergency care response during cardiac arrest situations, enhancing the quality of life upon the patients return of spontaneous consciousness. In a first implementation of the invention, there is device to guide an individual in performing CPR, the device having a housing with an interior and an exterior, the housing including: a timer circuit within the interior of the housing; at least two light sources in electronic communication with the timer circuit; an activation mechanism within the interior of the housing, the activation mechanism being in electronic communication with the timer circuit; and a power source in electronic communication with the timer circuit and the activation mechanism; wherein the activation mechanism is triggered by the removal of the release liner tab on an underside of the device.

In another aspect, the housing may be comprised of a foam product.

In another aspect, the housing may be rectangular in shape.

In another aspect, the interior portion of the housing may fully include the timer circuit, the battery, and the activation mechanism.

In another aspect, the interior portion may further include a portion of the plurality of light sources, wherein another portion of the light sources extends to the exterior portion of the housing.

In another aspect, the plurality of light sources may include a first light source, a second light source, and a third light source.

In another aspect, the timer circuit may be configured to provide the number of blinks per minute for a first light source, wherein the number of blinks represents the number of chest compressions per minute.

In another aspect, the timer circuit may be configured to have the second light source blink, wherein the blinking of the second light source represents the period of time during CPR where the rescuer provides rescue breaths to the patient.

In another aspect, the second light source may be turned on at the same time or at a different time from the first light source.

In another aspect, the third light source may be configured to provide the modality of the polarity of light sources.

In another aspect, the first light source may be a first color.

In another aspect, the second light source may be a second color.

In another aspect, the third light source may be a third color.

In another aspect, the release liner tab may be on the exterior portion of the housing.

In another aspect, the release liner tab may expose an skin compatible adhesive on a bottom side of the exterior portion of the housing.

In another aspect, the skin compatible adhesive may be adapted to fit on the body of a patient.

In another aspect, the device may be configured to be portable.

In another aspect, the device may be configured to be disposable.

In a second implementation of the invention, the device is to guide an individual in performing CPR, the device with a housing having an interior and an exterior, the housing including: a timer circuit within the interior; a first light source, a second light source, and a third light source in electronic communication with the timer circuit, wherein the first light source is configured to blink at a rate corresponding to a recommended number of chest compressions per minute, and wherein the second light source is configured to indicate timing for providing rescue breaths; wherein the third light source is configured to indicate the modality of CPR; one-man rescue, two-man rescue, and/or advanced airway resuscitation, an activation mechanism in electronic communication with the timer circuit; and a power source in electronic communication with the timer circuit and the activation mechanism, wherein the activation mechanism is triggered by removing a removable backing from a first exterior surface of the housing.

In another aspect, the timer circuit may be configured to provide the number of blinks per minute for the first light source, wherein the number of blinks represents the number of chest compressions per minute.

In another aspect, the first light source may blink at a rate between 100-120 blinks per minute.

In another aspect, the timer circuit may be configured to have the second light source blink, wherein the blinking of the second light source represents the period of time during CPR when the rescuer provides breaths to the patient.

In another aspect, the first light source, the second light source, and the third light source exhibit different colors.

In a third implementation of the invention of the device to guide an individual in performing CPR, the device having a minimum waterproof housing with an interior and an exterior, wherein the housing is comprised of a foam based product; a timer circuit within the interior of the housing; a first light source, a second light source, and a third light source, wherein the first light source is of a first color and configured to blink at a rate between 100-120 blinks per minute, and wherein the second light source is of a second color and configured to blink in synchronization with the first light source or indicate a period for providing rescue breaths during CPR, and wherein the third light source is of a third color and configured to remain consistent to indicate the modality of the rescue, and wherein the first light source, the second light source, and the third light source are each in electronic communication with the timer circuit; an activation mechanism in electronic communication with the timer circuit, wherein the activation mechanism is triggered by the removal of a release liner tab on the back of the housing; a battery in electronic communication with the timer circuit, the activation mechanism, the first light source, and the second light source These and other objects, features, and advantages of the present invention and its embodiments will become more readily apparent from the attached drawings and the detailed description that follows.

### BRIEF DESCRIPTION OF THE DRAWINGS

The original preferred embodiments of the invention will hereinafter be described in conjunction with the appended drawings provided to illustrate and not to limit the invention, where like designations denote like elements, and in which:

FIG. 1A presents a top isometric view of a device for performing CPR, shown in accordance with a first illustrative embodiment of the invention.

FIG. 1B presents a bottom isometric view of the device for performing CPR as illustrated in FIG. 1A, shown with a removable release liner tab partially removed.

FIG. 2 presents a perspective view of the device for performing CPR as illustrated in FIG. 1A and FIG. 1B, shown prior to adhering the device to a patient's skin and visible to the rescuer performing CPR.

FIG. 3 presents a top perspective view of the device for performing CPR as illustrated in FIG. 1A, shown with the internal components of the device within the housing of the device.

FIG. 4 presents a side view of the device for performing CPR as illustrated in FIG. 3, shown with the internal components of the device within the housing of the device.

FIG. 5 presents a sample circuit of the internal components within the housing for performing CPR as illustrated in FIG. 3.

FIGS. 6A-6D presents various embodiments in accordance with the present disclosure directed to infant/pediatric CPR and Adult CPR, both for basic or non-professional use and emergency management or professional use.

FIG. 7A presents a diagram showing the assembly of the release liner tab in conjunction with the battery compartment.

FIG. 7B presents a diagram showing the removal of the release liner tab, thereby activating the power source of the device.

### DETAILED DESCRIPTION OF THE EMBODIMENTS

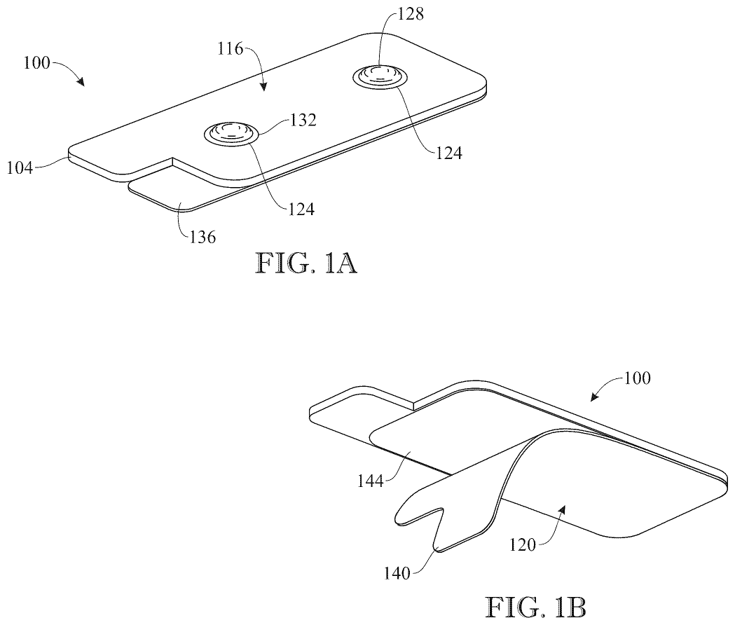

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper”, “lower”, “left”, “rear”, “right”, “front”, “vertical”, “horizontal”, and derivatives thereof shall relate to the invention as oriented in FIG. 1.

Furthermore, there is no intention to be bound by any expressed or implied theory presented in the preceding technical field, background, brief summary, or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

Shown throughout the figures, the present invention is directed toward a device for performing CPR that is designed and configured to be placed on the body of a patient in cardiac arrest such that a rescuer may be visually aware of the rate that chest compressions need to be provided, as well as the period of time at which rescue breaths are to be provided to the patient. The device may include a housing having an interior portion and an exterior portion. The interior portion of the housing may contain the majority of the components of the device, including a timer circuit, an activation mechanism, and a battery. The exterior portion of the housing may include a plurality of visual aids, such as a plurality of light sources, as well as an adhesive. The device operates by allowing a rescuer to use visual cues from the device to provide both chest compressions, as well as rescue breaths to the patient during CPR at the rate recommend by health guidelines. Additionally, the device is configured to start once the release liner tab is removed and allows for a rescuer to easily place the device on a body part of the patient.

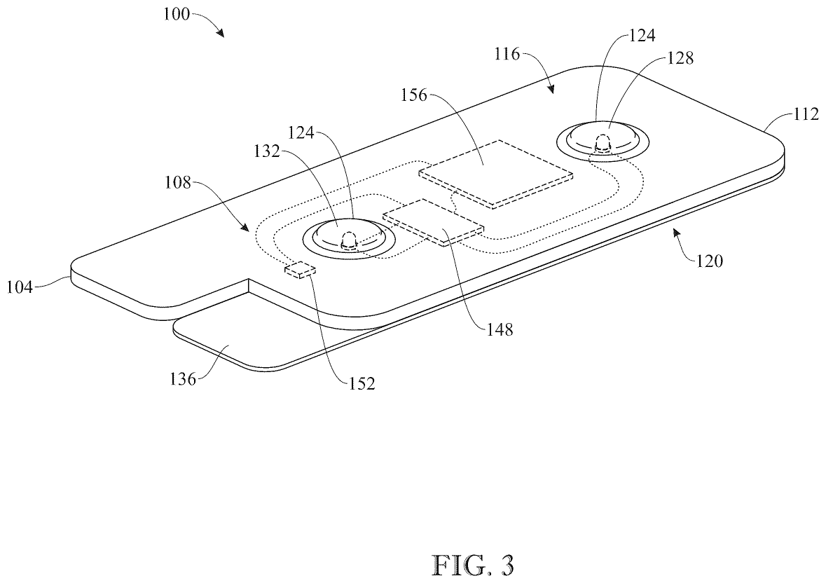

Referring initially to FIG. 3, a device for performing CPR 100 is illustrated in accordance with an exemplary embodiment of the original version of the invention. As shown, the device 100 includes a housing 104 having an interior 108 and an exterior 112. The housing 104 may be comprised of a foam based product, and in the preferred embodiment, may be rectangular. Embodiments are envisioned wherein the housing 104 may conform to any shape capable of housing all the requisite components. In other embodiments, the housing 104 may be comprised of or covered by a non-conductive material in the event the patient needs to be shocked with a defibrillator. Referring now to FIGS. 1A and 1B, the exterior portion of the housing 104 may include a top side 116 and a bottom side 120. The top side 116 may include a plurality of light sources 124. In the preferred embodiment, the plurality of light sources may include a first light source 128 and a second light source 132. In preferred embodiment, the plurality of light sources 124, first light source 128, and second light source 132 are light emitting diodes (LEDs). However, other suitable light emitting devices and/or light sources may be used under the purview of the present invention and its embodiments. Additionally, the top side 116 may include a depressed region having a tab 136.

With continued reference to FIG. 1B, the tab 136 may define a removable release liner tab 140 on the bottom side 120 of the exterior 112 of the housing 104. The removal of the release liner tab 140 may expose a skin compatible adhesive 144 on the bottom side 120 of the exterior 112 of the housing 104, wherein the adhesive 144 is configured to adhere to a body part of a patient.

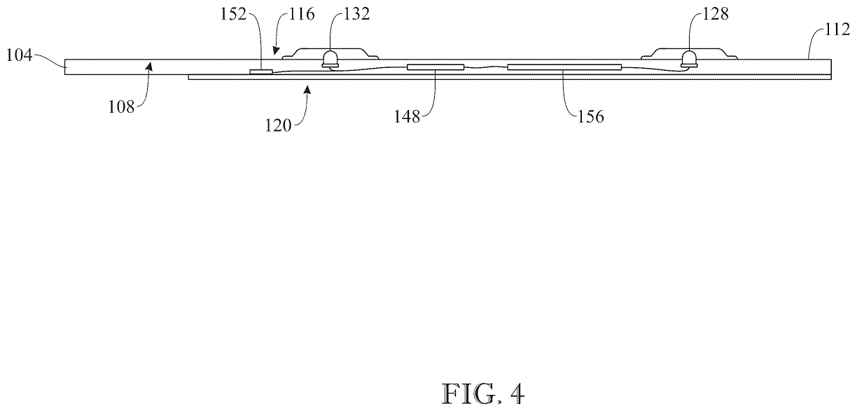

Referring back to FIG. 3, and also shown in FIG. 4, the housing 104 may include a number of interior components within the interior 108. These interior components may include a timer circuit 148, the aforementioned plurality of light sources 124, an activation mechanism 152, and a battery 156. The plurality of light sources 124 may be in electronic communication with the timer circuit 148, wherein the plurality of light sources extends from the interior 108 to the exterior 112. More particularly, the timer circuit 148 may be configured to provide the number of blinks per minute for the first light source 128, wherein the number of blinks represents the number of chest compressions per minute. The timer circuit 148 may also be configured to have the second light source blink 132, wherein the blinking of the second light source represents the period of time during CPR, the rescuer provides rescue breaths to the patient. The second light source 132 may be turned on at the same time or at a different time from the first light source 128. In the preferred embodiment, the first light source 128 and the second light source 132 may each be different colors.

With continued reference to FIG. 3, the battery 156 may be in electronic communication with the timer circuit 148 and the activation mechanism 152, providing power to each. Additionally, the activation mechanism 152 may be triggered by the removable release liner tab 140 on the exterior 112 of the housing 104. The activation mechanism 152 may then start the timer circuit 148 such that a rescuer may begin administering CPR.

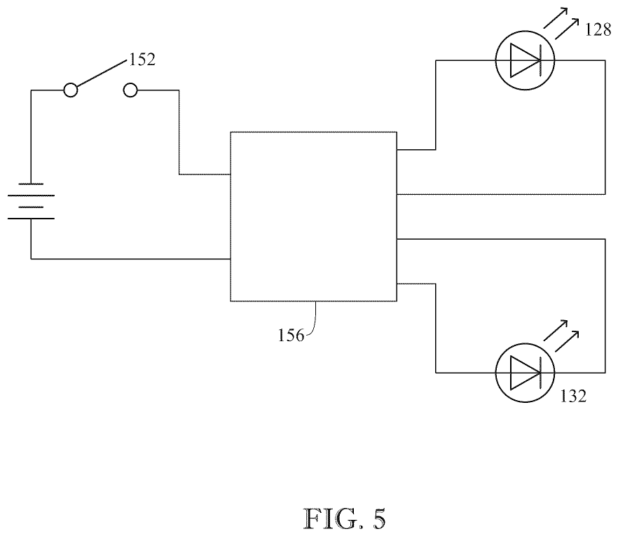

The timer circuit 148 is shown in FIG. 5. As shown, the activation mechanism 152 opens the circuit and sets off the first light source and the second light source at a set time interval. For instance, the first light source may blink at a rate of 100-120 blinks per minute, wherein the number of blinks represents the number of chest compressions per minute. Similarly, the second light source may blink after every 30 compressions, wherein the blinking of the second light source represents the period of time during CPR the rescuer provides rescue breaths to the patient.

The illustrations of FIGS. 1-3 demonstrate an example method of operation of the device for performing CPR 100 when a patient 164 may be experiencing cardiac arrest. The first step may involve having a rescuer 160 remove the removable release paper 140 by pulling on tab 136. Removing the release paper 140 allows for the adhesive 144 to be exposed. Upon exposing the adhesive 144, the device 100 may be placed on a body part of the patient 164. As shown, the device 100 is placed on the chest of the patient 166.

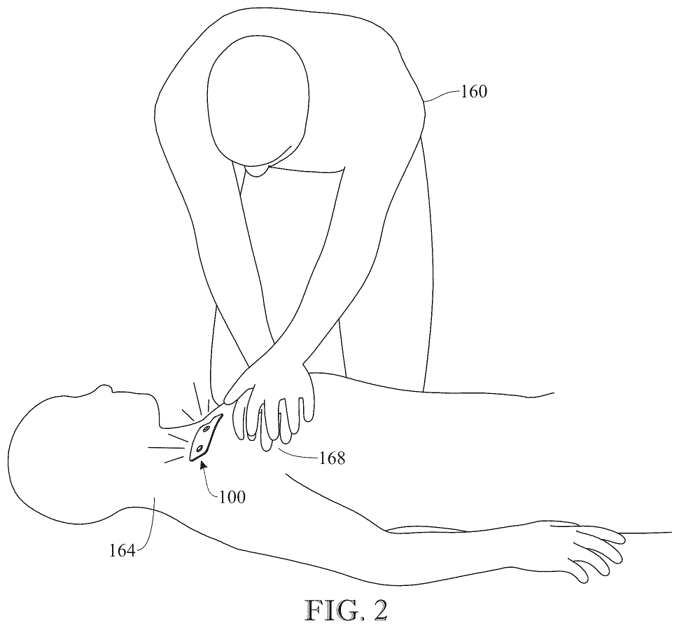

The next step involves having the activation mechanism 152 trigger the timer circuit 148 to start the plurality of light sources 124 upon removing the removable release paper 140. The timer circuit 148 may be configured to provide the number of blinks per minute for the first light source 128, wherein the number of blinks represents the number of chest compressions per minute. While the first light source blinks, the rescuer 160 may provide chest compressions 168, as best shown in FIG. 2, to the patient 164 at the rate given by a blink on a first light source 128 of the plurality of light sources 128. The first light source may blink at a rate of 100-120 blinks per minute. Upon providing chest compressions, the next step 300 may be having the rescuer 160 provide breaths to a patient upon a blinking of a second light source 132 of the plurality of light sources 124. The second light source may blink after every 30 compressions.

Alternative embodiments are contemplated to those shown or described herein without departing from the scope of the present disclosure. For example, embodiments are contemplated in which the timing of the light sources through the timer circuit may vary, such as if the patient is an infant or pediatric child, the timer circuit may be timed to provide chest compressions and breaths at a different rate. Additionally, embodiments are considered wherein the material of the housing of the device is made of a durable material such that the device may be able to be reused multiple times. Along those lines, the skin compatible adhesive may also be replaced with a reusable material.

In some embodiments, the timer circuit 148 may include an adjustment feature that allows the device to be calibrated based on the patient's age. This adjustability ensures that the device provides accurate and effective guidance for CPR regardless of whether the patient is an adult, pedatric, or infant. For pediatric/infant patients, the device may alter the blinking sequence of the light sources to indicate a higher frequency of breaths, in line with pediatric/infant CPR guidelines, which suggest a different compression to rescue breath ratio, particularly in a two-rescuer scenario.

The battery 156 used within the device is chosen for its long-life capabilities, ensuring that it can power the device for the duration of CPR, which may be extended in some emergency situations. The long-life battery mitigates the risk of the device failing due to power depletion during critical resuscitation efforts. Moreover, the battery may be user-replaceable, allowing the device to be prepared swiftly for reuse if necessary.

Further to the plurality of light sources, the device may incorporate a third light source dedicated to indicating the operational status of the device. This third light source could emit a distinct color or blink in a specific pattern to signal that the device is powered and functioning correctly. This feature provides immediate guidance to the rescuer, confirming that the visual cues for CPR are active and reliable.

In another embodiment, the device may feature a user interface integrated into the housing 104. This interface can include buttons or touch-sensitive areas that allow the rescuer to configure the timer circuit 148 before initiating CPR. Through this interface, the rescuer could set the device for different CPR protocols, adjust the rates of the light sources, or even pause and resume the visual cues as needed during the resuscitation process.

The housing 104 may also be enhanced with a waterproof coating or constructed from waterproof materials. This ensures that the device's components are protected from bodily fluids, which are often present in emergency situations. The waterproofing feature enhances the durability of the device and ensures it functions correctly even when exposed to such conditions. In summary, the device for performing CPR disclosed herein provides a more efficient and safer method of conducting CPR by providing visual cues to the rescuer with respect to the appropriate chest compression rate. Also, the device helps alert the rescuer to the appropriate time to provide rescue breaths to the patient. The device is easily portable and disposable after use, however, embodiments are envisioned where the device may be used multiple times before disposal.

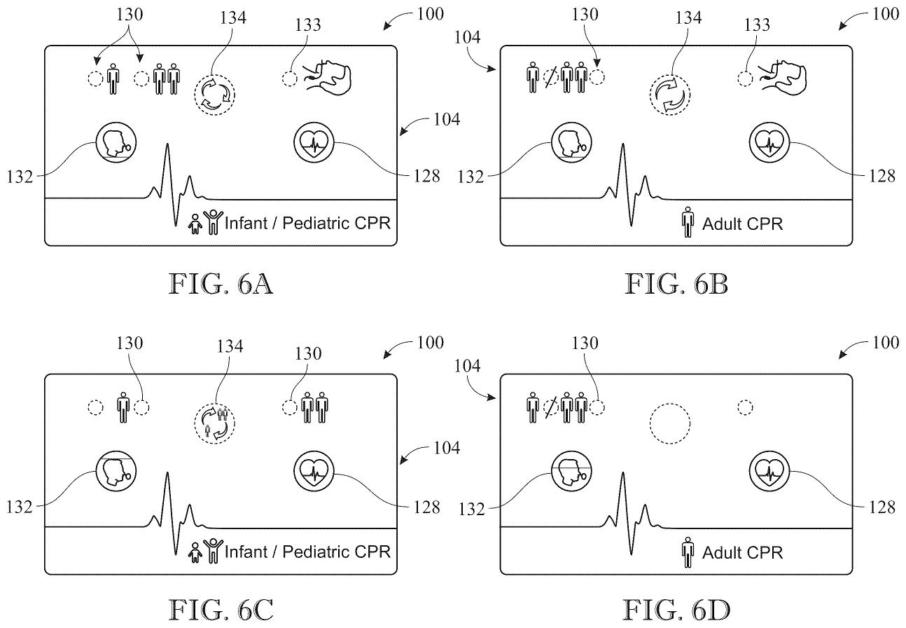

Turning now to FIGS. 6A-6D, shown are additional embodiments of the present invention designed for hospital/EMT professional use and separately for in-home or non-professional use. The embodiments are further broken down into those useful for infant/pediatric patients and those useful for adult patients.

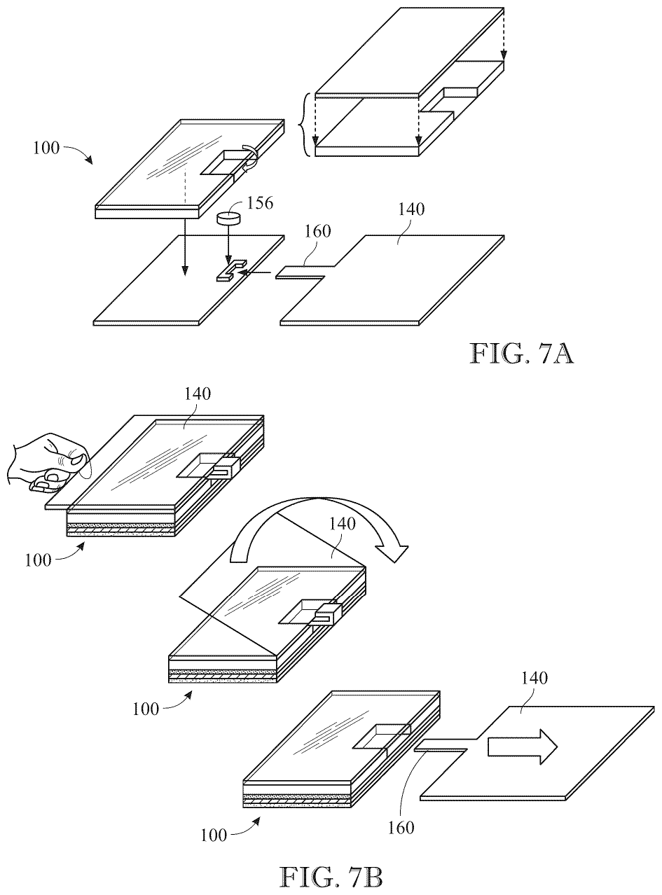

As shown in FIGS. 6A and 6C, there is a device 100 that can be generally used in the manner described herein. However, as shown in FIGS. 7A-B, the method of use and/or activation may differ slightly, as well as the incorporation of a mode selector 134, which modifies the operative functionality of the respective device 100.

As shown the device 100 generally has a mode selector 134, first light source 128 (preferably an LED), second light source 132 (preferably an LED), a housing 104, equipment indicator 133, and personnel indicator(s) 130. The key differentiating element between the version for use in a hospital/EMT setting as opposed to a non-professional setting is the inclusion of the equipment indicator 133 on the hospital/EMT version.

To use the devices 100 shown in FIGS. 6A-D, one must first select the correct device. Typically, the hospital/EMT version will only be available to those in a hospital or emergency management type setting. However, it may be appropriate to include all versions and equipment necessary to use all versions in a kit to make such available to those you may be able to effectively use the same. Otherwise, to select the correct device, one needs only to identify whether the patient is an infant/pediatric patient or an adult patient. Once selected, the device is activated by removing the removable release liner tab (see FIGS. 8A-B). The device 100 then begins to operate automatically.

First a user must select, using the mode selector 134, the correct operative mode The mode selector 134 is preferably a depressible button, but may also comprise a touch surface, toggle switch, or other appropriate selection mechanism. In the event that the non-professional, adult version is being used (as shown in FIG. 6D), there is no mode selector as only one mode is appropriate for use

The mode selector 134 generally allows one of the following modes to be selected: one person CPR, two person CPR, advanced airway CPR. Each press of the mode selector 134, if present, will cause a status LED to emit light next to a corresponding icon. Under the personnel indicator 130 either the light for one person CPR or the light for two person CPR may be selected. Further interacting with the mode selector 134, can also cause, if present, the advanced airway or equipment indicator light to illuminate. Once the proper mode is selected and confirmed by the appearance of the visual light next to the mode, CPR can begin. Further, in some embodiments, one rescuer may begin one-man CPR, then when another rescuer is present, the toggle can be hit again to guide two-man CPR. Even further, when a licensed professional inserts an advanced airway, the toggle can be hit yet again to move the light to the advanced airway for CPR per guidelines. Various other permutations of the foregoing can be employed depending on the number of rescuers as well as the availability of a licensed professional.

Referring back to the activation of the device, the first light source 128 blinks at an appropriate rate to show when the chest compressions are to be applied to the patient synchronously with the blink of the first light source 128. The second light source 132 blinks at an appropriate rate and time to show when a rescue breath is to be applied to the patient.

In a preferred embodiment, the status light source(s) or LEDs indicating the mode selected are yellow in color, the first light source 128 is red in color, and the second light source 132 is green in color. This helps the users of the device 100 readily discern and identify the individual lights and actions to be taken upon such a visual indicator during CPR.

Each of the four embodiments shown in FIGS. 6A-D with the respective modes applicable to each embodiment are further outlined below.

### Hospital/EMT Advanced Airway Infant/Pediatric

### 3 Modes to Toggle Between:

1. 1-man CPR
   30 red LED blinks (@ 110 BPM) and stops
   0.5 sec delay
   Green LED comes on for 1 sec
   Off for 1 second
   Green LED comes on for 1 sec again
   Delay for 0.5 sec
   Red LED blinks again (starts new cycle of 30 red blinks, etc. again)
2. 2-man CPR
   15 red LED blinks (@ 110 BPM) and stops
   0.5 sec delay
   Green LED comes on for 1 sec
   Off for 1 second
   Green LED comes on for 1 sec again
   Delay for 0.5 sec before
   Red LED blinks again (starts new cycle of 15 red blinks, etc. again)
3. Advanced Airways CPR
   Red LED blinks continuously@ 110 BPM.
   While the red LED is blinking continuously, the green LED will blink every 3 seconds (ON for 1 second, OFF for 2 seconds)

### Hospital/EMT Advanced Airway Adult

### 2 Modes to Toggle Between:

1. ½-man CPR
   30 red LED blinks (@ 110 BPM) and stops
   0.5 sec delay
   Green LED comes on for 1 sec
   Off for 1 second
   Green LED comes on for 1 sec again
   Delay for 0.5 sec
   Red LED blinks again (starts new cycle of 30 red blinks, etc. again)
2. Advanced Airways CPR
   Red LED blinks continuously@ 110 BPM.
   While the red LED is blinking continuously, the green LED will blink once every 6 seconds (ON for 1 second, OFF for 5 seconds)

### Non-Professional Use Infant/Pediatric

### 2 Modes to Toggle Between:

1. 1-man CPR
   30 red LED blinks (@ 110 BPM) and stops
   0.5 sec delay
   Green LED comes on for 1 sec
   Off for 1 second
   Green LED comes on for 1 sec again
   Delay for 0.5 sec
   Red LED blinks again (starts new cycle of 30 red blinks, etc. again)
2. 2-man CPR
   15 red LED blinks (@ 110 BPM) and stops
   0.5 sec delay
   Green LED comes on for 1 sec
   Off for 1 second
   Green LED comes on for 1 sec again
   Delay for 0.5 sec before
   Red LED blinks again (starts new cycle of 15 red blinks, etc. again)

### Non-Professional Use Adult

### Single Mode:

1. ½-man CPR
   30 red LED blinks (@ 110 BPM) and stops
   0.5 sec delay
   Green LED comes on for 1 sec
   Off for 1 second
   Green LED comes on for 1 sec again
   Delay for 0.5 sec
   Red LED blinks again (starts new cycle of 30 red blinks, etc. again)

Turning now to FIGS. 7A-B, the assembly and activation of the release liner tab 140 of the device 100 is shown. The removable backing or removable release liner tab 140 is configured to interact with a portion of the device such that it interrupts electrical power from being supplied to the device 100 when the removable backing 140 is in position on the housing 104. In a preferred embodiment, the removable backing 140 has a tab 162. The tab 162 may be shaped and sized as appropriate to engage a portion of the device 100.

When the power source or battery 156 is to be inserted into the device 100, the tab 162 is first inserted into a portion of the battery compartment. This allows for the tab 162 to be positioned between the metal contacts of the battery compartment and the battery 156. When the removable backing 140 is removed from the housing 104 of the device 100, the tab 162 is removed from its position between the metal contacts and the battery 152, thereby allowing the circuit between the battery 162 and the metal contacts to be completed. This, in turn, activates the device 100.

The removable release liner tab 140 is configured to preferably allow for the removable release liner tab 140 to be removed in any fashion (pulled at an angle, along an edge, etc.) to activate the device 100. The only requirement is preferably that the tab 162 is removed from its position to establish the circuit, and enough skin-compatible adhesive is exposed to create as secure adhesion to the patient as previously described herein.

Since many modifications, variations, and changes in detail can be made to the described preferred embodiments of the invention, it is intended that all matters in the foregoing description and shown in the accompanying drawings be interpreted as illustrative and not in a limiting sense. Furthermore, it is understood that any of the features presented in the embodiments may be integrated into any of the other embodiments unless explicitly stated otherwise. The scope of the invention should be determined by the appended claims and their legal equivalents.

What is claimed is:

1. A device to guide an individual in performing CPR, the device comprising:
a housing having an interior and an exterior, the housing including:
a timer circuit within the interior of the housing;
at least two light sources in electronic communication with the timer circuit;
an activation mechanism within the interior of the housing, the activation mechanism being in electronic communication with the timer circuit;
and
a power source in electronic communication with the timer circuit and the activation mechanism;
wherein the activation mechanism is triggered by a removable backing disposed on an underside of the device.

2. The device of claim 1, further comprising a selection indicator configured to select an operative state of the device.

3. The device of claim 1, wherein the housing is comprised of a foam-based product.

4. The device of claim 1, wherein the at least two light sources include a first light emitting diode and a second light emitting diode.

5. The device of claim 4, wherein the first light emitting diode is configured to blink at a rate corresponding to a recommended number of chest compressions per minute.

6. The device of claim 4, wherein the second light emitting diode is configured to indicate a timing for providing rescue breaths to a patient.

7. The device of claim 4, wherein the first light emitting diode blinks in a pattern distinct from a pattern of the second light emitting diode.

8. The device of claim 4, wherein light emitted from the first light emitting diode is a first color, and light emitted from the second light emitting diode is a second color.

9. The device of claim 1, wherein the removable backing covers an adhesive disposed on the underside of the housing.

10. The device of claim 9, wherein the removable backing, when removed, exposes the adhesive.

11. The device of claim 1, wherein the adhesive is hypoallergenic.

12. The device of claim 1, wherein the activation mechanism is coupled to the power source.

13. The device of claim 1, wherein the timer circuit is adjustable based on an age of a patient.

14. The device of claim 1, wherein the power source is a battery.

15. The device of claim 1, wherein the housing further includes a waterproof coating.

16. A device to assist an individual in performing CPR, the device comprising:
a housing having an interior and an exterior, the housing including:
a timer circuit within the interior;
a first light source and a second light source in electronic communication with the timer circuit,
wherein the first light source is configured to blink at a rate corresponding to a recommended number of chest compressions per minute, and
wherein the second light source is configured to indicate timing for providing rescue breaths;
an activation mechanism in electronic communication with the timer circuit; and
a power source in electronic communication with the timer circuit and the activation mechanism,
wherein the activation mechanism is triggered by removing a removable backing from a first exterior surface of the housing.

17. A device to assist an individual in performing CPR, the device comprising:
a waterproof housing having an interior and an exterior,
wherein the housing is comprised of a foam-based product;
a timer circuit within the interior of the housing;
a first light source and a second light source,
wherein the first light source is of a first color and configured to blink at a rate of 100-120 blinks per minute, and
wherein the second light source is of a second color and configured to blink in synchronization with the first light source or indicate a period for providing resuscitative breaths during CPR, and
wherein the first light source and the second light source are each in electronic communication with the timer circuit;
an activation mechanism in electronic communication with the timer circuit,
wherein the activation mechanism is triggered by the removal of a removable backing from the housing;
a battery in electronic communication with the timer circuit, the activation mechanism, the first light source, and the second light source.
